(19) United States
(12) Patent Application Publication
(10) Pub. No.: US 2020/0314658 A1
(43) Pub. Date: Oct. 1, 2020

(54) METHODS AND APPARATUS FOR SCHEDULING IN LAA

(71) Applicant: TELEFONAKTIEBOLAGET LM ERICSSON (PUBL), Stockholm (SE)

(72) Inventors: Mattias BERGSTRÖM, SOLLENTUNA (SE); Marco BELLESCHI, SOLNA (SE); Reem KARAKI, AACHEN (DE)

(73) Assignee: TELEFONAKTIEBOLAGET LM ERICSSON (PUBL), Stockholm (SE)

(21) Appl. No.: 16/759,609

(22) PCT Filed: Oct. 26, 2018
(86) PCT No.: PCT/IB2018/058399

§ 371 Date: Apr. 27, 2020

Related U.S. Application Data
(60) Provisional application No. 62/577,919, filed on Oct. 27, 2017.

(51) Int. Cl. H04W 16/14; H04W 72/04; H04W 72/12; H04W 74/08; H04W 72/14

(52) U.S. Cl. CPC H04W 16/14; H04W 72/0413; H04W 72/14; H04W 74/0808; H04W 72/1289

(57) ABSTRACT

There is provided a method in a wireless device for Licensed Assisted Access (LAA). The method comprises: receiving a first and a second opportunities for performing a first uplink transmission within a period of time, the first opportunity being received earlier than the second opportunity within the period of time; performing the receiving a first and a second opportunities for performing a first first uplink transmission using the first opportunity; and determining uplink transmission within a period of time, the first opportunity. A wireless device for performing this method is provided as well.

### RELATED APPLICATIONS

The present application claims the benefits of priority of U.S. Provisional Patent Application No. 62/577,919, entitled “Suppression of Early Subsequent Transmissions”, and filed at the United States Patent and Trademark Office on Oct. 27, 2017, the content of which is incorporated herein by reference.

### TECHNICAL FIELD

The present description generally relates to wireless communication systems and more specifically to transmissions in Licensed-Assisted Access (LAA).

### BACKGROUND

The Third Generation Partnership Project (3GPP) work on “Licensed-Assisted Access” (LAA) intends to allow Long Term Evolution (LTE) equipment to also operate in the unlicensed radio spectrum. Candidate bands for LTE operation in the unlicensed spectrum include 5 GHz, 3.5 GHz, etc. The unlicensed spectrum is used as a complement to the licensed spectrum or allows completely standalone operation.

For the case of unlicensed spectrum used as a complement to the licensed spectrum, devices connect in the licensed spectrum (through the primary cell (PCell)) and use carrier aggregation to benefit from additional transmission capacity in the unlicensed spectrum (through a secondary cell (SCell)). The carrier aggregation (CA) framework allows to aggregate two or more carriers with the condition that at least one carrier (or frequency channel) is in the licensed spectrum and at least one carrier is in the unlicensed spectrum. In the standalone (or completely unlicensed spectrum) mode of operation, one or more carriers are selected solely in the unlicensed spectrum.

Regulatory requirements, however, may not permit transmissions in the unlicensed spectrum without prior channel sensing, transmission power limitations or imposed maximum channel occupancy time. Since the unlicensed spectrum must be shared with other radios of similar or dissimilar wireless technologies, a so-called listen-before-talk (LBT) method needs to be applied. LBT involves sensing the medium for a pre-defined minimum amount of time and backing off if the channel is busy. Due to the centralized coordination and dependency of terminal devices on the base-station (eNB) for channel access in LTE operation and imposed LBT regulations, LTE uplink (UL) performance is especially hampered. UL transmission is becoming more and more important with user-centric applications and the need for pushing data to the cloud.

Today, the unlicensed 5 GHz spectrum is mainly used by equipment implementing the IEEE 802.11 Wireless Local Area Network (WLAN) standard. This standard is known under its marketing brand “Wi-Fi” and allows completely standalone operation in the unlicensed spectrum. Unlike the case in LTE, Wi-Fi terminals can asynchronously access the medium and thus show better UL performance characteristics especially in congested network conditions.

LTE Uplink Scheduling Schemes

In LTE, the uplink access is typically controlled by eNB, i.e., scheduled. In this case, the User Equipment (UE) would report to the eNB when data is available to be transmitted, e.g., by sending a scheduling request message (SR). Based on this, the eNB would grant the resources and relevant information to the UE in order to carry out the transmission of a certain size of data. The assigned resources are not necessarily sufficient for the UE to transmit all the available data. Therefore, it is possible that the UE sends a buffer status report (BSR) control message in the granted resources, in order to inform the eNB about the correct size and updated size of the data waiting for transmission. Based on that, the eNB would further grant the resources to carry on with the UE uplink transmission of the corrected size of data.

In more detail, every time new data arrive at the UE's empty buffer, the following procedure should be performed:

1. Using Physical Uplink Control Channel (PUCCH), the UE informs the network that it needs to transmit data by sending a Scheduling Request (SR) indicating that it needs uplink access. The UE has a periodic timeslot for SR transmissions (typically on a 5, 10, or 20 ms interval).

2. Once the eNB receives the SR request bit, it responds with a small “uplink grant” that is just large enough to communicate the size of the pending buffer. The reaction to this request typically takes 3 ms.

3. After the UE receives and processes (takes about 3 ms) its first uplink grant, it typically sends a Buffer Status Report (BSR), that is a Media Access Control (MAC) Control Element (CE), for indicating information about the amount of pending data in the uplink buffer of the UE. If the grant is big enough, the UE sends data from its buffer within this transmission as well. Whether the BSR is sent depends also on conditions specified in 3GPP TS 36.321.

4. The eNB receives the BSR message, allocates the necessary uplink resources and sends back another uplink grant that will allow the device to drain its buffer.

Adding it all up, about 16 ms (+time to wait for PUCCH transmission opportunity) of delay can be expected between data arrival at the empty buffer in the UE and reception of this data in the eNB.

Another scheduling option specified in LTE is the so-called semi-persistent scheduling (SPS). One or more SPS configurations can be assigned to a certain UE. Each SPS configuration addresses a set of periodically recurring resources which are to be considered as uplink grant for LTE transmissions. The eNB can (de)activate each SPS configuration via Downlink Control Information (DCI) on Physical Downlink Control Channel (PDCCH). Once the SPS configuration is activated, the UE can use the associated resources. If an SPS configuration is deactivated, the UE should stop using the associated resources.

A key point in classic uplink LTE scheduling is that there is a fixed one-to-one association between a Transmit Time Interval (TTI) and a Hybrid Automatic Repeat request (HARQ) Identifier (ID). In this way, the eNB has full control of the status of the different HARQ processes.

License Assisted Access

Up to now, the spectrum used by LTE is dedicated to LTE. This has the advantage that LTE system does not need to care about coexistence issues and the spectrum efficiency can be maximized. However, the spectrum allocated to LTE is limited, as such, it cannot meet the ever increasing demand for larger throughput from applications/services. Therefore, Release 13 (Rel-13) LAA extended LTE to exploit the unlicensed spectrum in addition to the licensed spectrum. Unlicensed spectrum can, by definition, be simultaneously used by multiple different technologies. Therefore, LTE needs to consider the coexistence issue with other systems such as IEEE 802.11 (Wi-Fi). Operating LTE in the same manner in unlicensed spectrum as in licensed spectrum can seriously degrade the performance of Wi-Fi as Wi-Fi will not transmit once it detects the channel is occupied.

Furthermore, one way to utilize the unlicensed spectrum reliably is to transmit essential control signals and channels on a licensed carrier. That is, as shown in FIG. 1, a UE 110 is connected to a PCell 120 in the licensed band and one or more SCells 130 in the unlicensed band. In this disclosure, a secondary cell in the unlicensed spectrum is denoted as a licensed-assisted access secondary cell (LAA SCell). In the case of standalone operation as in MulteFire, no licensed cell is available for uplink control signal transmissions.

HARQ Design

For the LAA, asynchronous HARQ is recommended for LAA UL (using Physical Uplink Shared Channel (PUSCH)). That means UL retransmissions may not only occur in one Round Trip Time (RTT) (e.g. n+8) after the initial transmission but rather at any point in time. This is considered beneficial in particular when retransmissions are blocked and postponed due to LBT. When introducing asynchronous HARQ, the UE should therefore assume that all transmitted UL HARQ processes were successful (e.g. by setting local status to ACK). The UE performs a HARQ retransmission for a HARQ process only upon reception of a corresponding UL Grant (New Data Indicator (NDI) not toggled) from the eNB.

Downlink HARQ

After reception of the PDCCH/Evolved PDCCH (EPDCCH) and associated PDSCH in subframe ‘n’, the UE shall have the associated HARQ feedback ready for transmission in subframe ‘n+4’. The UE shall transmit any pending HARQ feedback at the earliest possible uplink transmission opportunity following the ‘n+4’ constraint. When transmitting the HARQ feedback associated with the PDSCH, the UE shall collect pending feedback. The pending HARQ feedback may potentially include feedback for several downlink transmissions. The pending HARQ feedback is collected in a bitmap with an implicit association between the index in the bitmap and the HARQ process ID. The size of this bitmap is configurable by the eNB. The maximum number of HARQ processes for DL operation is 16. When signaled in MF-ePUCCH/sPUCCH bitmap, the default status of a HARQ-ID packet is NACK unless there is an ACK available to be sent.

Uplink HARQ

Asynchronous UL HARQ operation were introduced in LTE Rel-13 for eMTC (evolved Machine Type Communications). There is no support for non-adaptive HARQ operation, and the UE shall ignore any information content on the Physical Hybrid-ARQ Indicator Channel (PHICH) resources with respect to HARQ operation. The PHICH resources are maintained as part of the downlink transmission resources, but the information content is reserved for future use. Any uplink transmission (new transmission or retransmission of a given HARQ process) is explicitly scheduled through UL grant via PDCCH/EPDCCH, and for such reason, this type of scheduling is often referred to as SUL (scheduled uplink) or dynamic scheduled uplink. However, also in this type of asynchronous mechanism, there is still a relationship between the HARQ IDs and the TTIs, so that the eNB control is still fully possible to some extent. Also, to perform a retransmission, the UE has to wait for an explicit UL grant provided by the network. In particular, the eNB may request a retransmission for a certain HARQ process by not toggling the NDI bit for that HARQ process. The eNB may send the PDCCH to trigger a retransmission of an HARQ process at the expiry of the HARQ RTT associated with that HARQ process or (if configured) at any Discontinuous Reception (DRX) occasion in which the UE is supposed to monitor the DL channel. For example, in Re1.14, the eNB has the possibility to configure a DRX retransmission timer (i.e. drx-ULRetransmissionTimer) which is triggered at the expiry of the HARQ RTT. This timer allows the eNB to better counteract possible LBT occurrences which may prevent the eNB from correctly delivering the PDCCH as soon as possible after the HARQ RTT expiry.

Autonomous Uplink Access (AUL) for LAA/MultiFire

The usage of autonomous uplink access (AUL) for LAA is considered within the umbrella of 3GPP Re1.15, as well as in the MultiFire standardization body.

For the LTE UL channel access, both UE and eNB need to perform LBT operations corresponding to the scheduling request, scheduling grant and data transmission phases. In contrast, Wi-Fi terminals only need to perform LBT once in the UL data transmission phase. Moreover, Wi-Fi terminals can asynchronously send data compared to the synchronized LTE system. Thus, Wi-Fi terminals have a natural advantage over LTE terminals in UL data transmissions and show superior performance in collocated deployment scenarios as seen in simulation studies. Overall study results show that Wi-Fi has a better uplink performance than LTE particularly in low-load or less congested network conditions. As the network congestion or load is increased, the LTE channel access mechanism (Time Division Multiplexing Access (TDMA) type) becomes more efficient, but Wi-Fi uplink performance is still superior. For example, a UE can start the UL transmission without waiting for permission from the eNB. In other words, a UE can perform LBT to gain UL channel access whenever the UL data arrive without transmitting a SR or having an UL grant from the eNB. The UE can use the autonomous mode for the whole data transmission or alternatively, transmits using the autonomous mode for first N transmission bursts and then switches back to the eNB controlled scheduling mode.

Autonomous uplink access (AUL) can be simply represented by a semi-persistent scheduling (SPS) configuration where uplink grant periodically recur following a certain periodic interval. Compared with the legacy LTE SPS, the difference would be that, in AUL, it would be up to the UE implementation when to perform (re)transmissions of a certain HARQ process, and under certain conditions also whether to perform a new transmission or a retransmission. On the other hand, in the legacy LTE SPS, each TTI is associated with a certain HARQ process that the UE has to transmit when performing UL transmission on such TTI. Similarly, the decision whether to perform a transmission or retransmission should follow the network indication (e.g. ACK/NACK on PHICH or PDCCH NDI indication). This implies that in AUL, the UE needs to signal to the eNB (e.g. in the Uplink Control Information (UCI)) to which HARQ process, the data transmitted on a certain PUSCH refer to.

Therefore, with the introduction of AUL in 3GPP Re1.15 and in the Multifire, two types of scheduling strategies can coexist, at the same time, i.e. the SUL scheduler and the AUL scheduler.

When both AUL and SUL are used to schedule LAA, some coexistence issues between these two scheduling strategies may arise. As such, there is a need of improved scheduling strategies.

### SUMMARY

As mentioned above, when both AUL and SUL are used to schedule LAA, some coexistence issues between these two scheduling strategies may arise.

In the AUL scheme, the eNB is not aware of which HARQ process the UE intends to transmit on a certain TTI (since there is no association between TTI and HARQ ID to be transmitted), and whether the UE intends to transmit at all.

For this reason, the eNB may schedule a certain HARQ process and transmit a SUL grant for that, while at the same time the UE has already started the preparation of AUL transmission of the same HARQ process, or the UE has just transmitted the AUL for such a HARQ process.

When the above situations occur, the UE behavior might be ambiguous.

Certain aspects of the present disclosure and their embodiments may provide solutions to these or other challenges.

According to one aspect, some embodiments include a method performed by a wireless device for Licensed Assisted Access (LAA). The method comprises: receiving a first and a second opportunities for performing a first uplink transmission within a period of time, the first opportunity being received earlier than the second opportunity within the period of time; performing the first uplink transmission using the first opportunity; and determining a treatment of the second opportunity based on the first opportunity.

In some embodiments, determining the treatment of the second opportunity may comprise suppressing the second opportunity in response to determining that the uplink transmission using the first opportunity was successful.

According to a second aspect, a wireless device is provided.

According to a third aspect, a wireless device comprising circuitry is provided. The circuitry may include one or more processors and memory. The wireless device is operable to perform steps according to embodiments of methods disclosed herein, according to the various aspects.

According to a fourth aspect, some embodiments include a wireless device configured, or operable, to perform one or more functionalities (e.g. actions, operations, steps, etc.) as described herein.

In some embodiments, the wireless device may comprise one or more communication interfaces configured to communicate with one or more other radio nodes and/or with one or more network nodes, and processing circuitry operatively connected to the communication interface, the processing circuitry being configured to perform one or more functionalities as described herein. In some embodiments, the processing circuitry may comprise at least one processor and at least one memory storing instructions which, upon being executed by the processor, configure the at least one processor to perform one or more functionalities as described herein.

In some embodiments, the wireless device may comprise one or more functional modules configured to perform one or more functionalities as described herein.

According to a fifth aspect, some embodiments include a non-transitory computer-readable medium storing a computer program product comprising instructions which, upon being executed by processing circuitry (e.g., at least one processor) of the wireless device, configure the processing circuitry to perform one or more functionalities as described herein.

According to a sixth aspect, computer programs, computer readable media configured to process and/or store instructions for steps according to embodiments of the methods disclosed herein, according to the various aspects, are also provided.

According to a sixth aspect, there is provided a method in a network node for Licensed Assisted Access (LAA). The method comprises: sending a grant to a wireless device for indicating an uplink transmission opportunity during a period of time; receiving, during the period of time, an uplink transmission using resources not indicated by the sent grant; in response to receiving the uplink transmission, sending an indication to the wireless device to suppress the sent grant before the period of time expires.

According to a seventh aspect, there is provided a method in a network node for Licensed Assisted Access (LAA). The method comprises: receiving a uplink transmission during a time period, from a wireless device; in response to receiving the uplink transmission, suppressing scheduling a grant to the wireless device, for indicating uplink transmissions, before the period of time expires.

According to another aspect, a network node comprising circuitry is provided. The circuitry may include one or more processors and memory. The network node is operable to perform steps according to embodiments of methods disclosed herein, according to the various aspects. Some embodiments include a network node configured, or operable, to perform one or more network node functionalities (e.g. actions, operations, steps, etc.) as described herein.

In some embodiments, the network node may comprise one or more communication interfaces configured to communicate with one or more other radio nodes and/or with one or more network nodes, and processing circuitry operatively connected to the communication interface, the processing circuitry being configured to perform one or more network node functionalities as described herein. In some embodiments, the processing circuitry may comprise at least one processor and at least one memory storing instructions which, upon being executed by the processor, configure the at least one processor to perform one or more network node functionalities as described herein.

In some embodiments, the network node may comprise one or more functional modules configured to perform one or more network node functionalities as described herein.

Some embodiments include a non-transitory computer-readable medium storing a computer program product comprising instructions which, upon being executed by processing circuitry (e.g., at least one processor) of the network node, configure the processing circuitry to perform one or more network node functionalities as described herein.

According to other aspects, computer programs, computer readable media configured to process and/or store instructions for steps according to embodiments of the method disclosed herein, according to the various aspects, are also provided.

Certain embodiments of aspects of the present disclosure may provide one or more technical advantages. For example, the embodiments allow to avoid UE behavior ambiguity when both a grant for AUL transmission and a grant for SUL transmission are available to the UE for a given UL transmission.

This summary is not an extensive overview of all contemplated embodiments, and, is not intended to identify key or critical aspects or features of any or all embodiments or to delineate the scope of any or all embodiments. In that sense, other aspects and features will become apparent to those ordinarily skilled in the art upon review of the following description of specific embodiments in conjunction with the accompanying figures.

### BRIEF DESCRIPTION OF THE DRAWINGS

Exemplary embodiments will be described in more detail with reference to the following figures, in which:

FIG. 1 illustrates a schematic diagram of Licensed assisted access (LAA) to unlicensed spectrum using LTE carrier aggregation.

FIG. 2 is an illustration of a co-existence issue when both AUL and SUL can be used.

FIG. 3 illustrates an example of early subsequent transmission, according to an embodiment.

FIG. 4 illustrates another example of early subsequent transmission, according to an embodiment.

FIG. 5 is a flow chart of a method in a wireless device for LAA, according to an embodiment.

FIG. 6 is a flow chart of a method in a network node for LAA, according to an embodiment.

FIG. 7 is a flow chart of another method in a network node for LAA, according to an embodiment.

FIG. 8 illustrates a schematic block diagram of a wireless device/UE according to an embodiment.

FIG. 9 illustrates a schematic block diagram of a network node according to an embodiment.

FIG. 10 illustrates a schematic block diagram of a wireless network, according to an embodiment.

FIG. 11 illustrates a schematic block diagram of User Equipment, according to an embodiment.

FIG. 12 illustrates a virtualization environment in accordance with some embodiments.

FIG. 13 illustrates a schematic block diagram of a telecommunication network connected via an intermediate network to a host computer, according to an embodiment.

FIG. 14 illustrates a schematic block diagram of a host computer communicating via a base station with a user equipment over a partially wireless connection, according to an embodiment.

FIG. 15 is a flowchart illustrating a method implemented in a communication system including a host computer, a base station and a user equipment, according to an embodiment.

FIG. 16 is a flowchart illustrating a method implemented in a communication system including a host computer, a base station and a user equipment according to an embodiment.

FIG. 17 is a flowchart illustrating a method implemented in a communication system including a host computer, a base station and a user equipment, according to an embodiment.

FIG. 18 is a flowchart illustrating a method implemented in a communication system including a host computer, a base station and a user equipment, according to an embodiment.

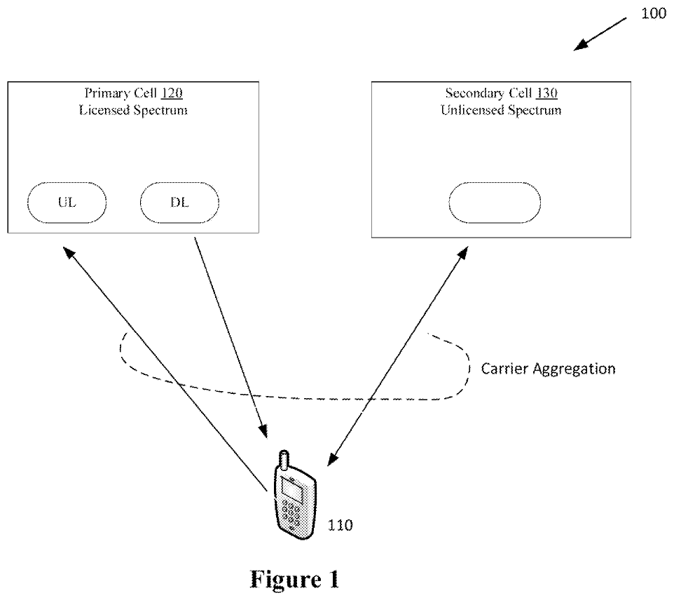

### DETAILED DESCRIPTION

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

As mentioned above, when both AUL and SUL are used to schedule LAA, some coexistence issues between these two scheduling strategies may arise.

In the AUL scheme, the eNB is not aware of which HARQ process the UE intends to transmit on a certain TTI (since there is no association between TTI and HARQ ID to be transmitted), and whether the UE intends to transmit at all.

For this reason, the eNB may schedule a certain HARQ process and transmit a SUL grant for that, while at the same time the UE has already started the preparation of AUL transmission of the same HARQ process, or the UE has just transmitted the AUL for such a HARQ process.

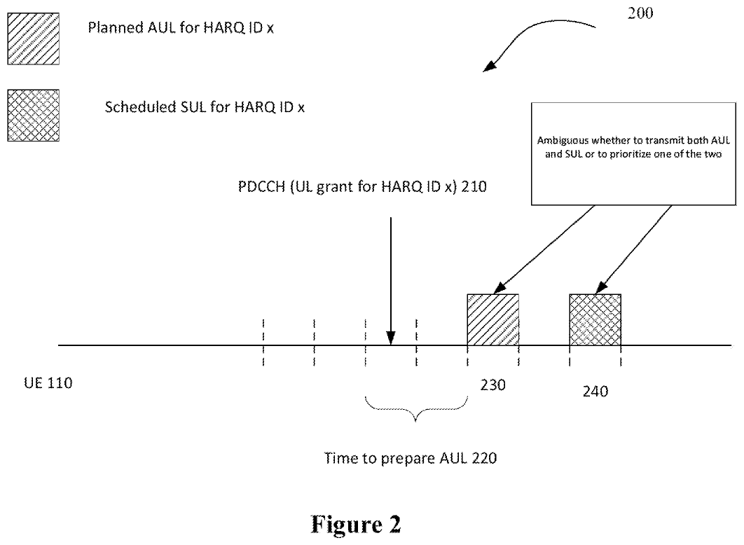

When the above situations occur, the UE behavior might be ambiguous. This issue is illustrated in FIG. 2. For example, the UE 110 receives a PDCCH for an UL grant, at step 210, for the transmission of data associated with the HARQ process x. Around the same time, at step 220, the UE may prepare to perform an AUL.

When this situation occurs, the UE behavior might be ambiguous, because some UEs might be capable of performing both transmissions (steps 230 and 240), while some other UEs might need to discard one of the two grants. Therefore, the way to solve this issue, and the associated UE behavior should be captured in the standard specification.

This disclosure describes ways in which the UE can handle situations where the UE, based on the transmission grants it has acquired, is requested to perform multiple transmissions for a certain HARQ process within a certain time T. As an example, the scenario where the UE is requested to perform two transmissions within a time T will be considered hereinbelow. However, the embodiments herein can be generalized and could be applied to scenarios where the UE is requested to perform more than two transmissions within the time T.

According to some embodiments, the UE will suppress one of the two transmissions, implying that one of the two grants associated with the two transmissions is ignored.

According to some embodiments, the UE will perform both transmissions, even if they are within a time T.

Suppressing Early Subsequent Transmissions

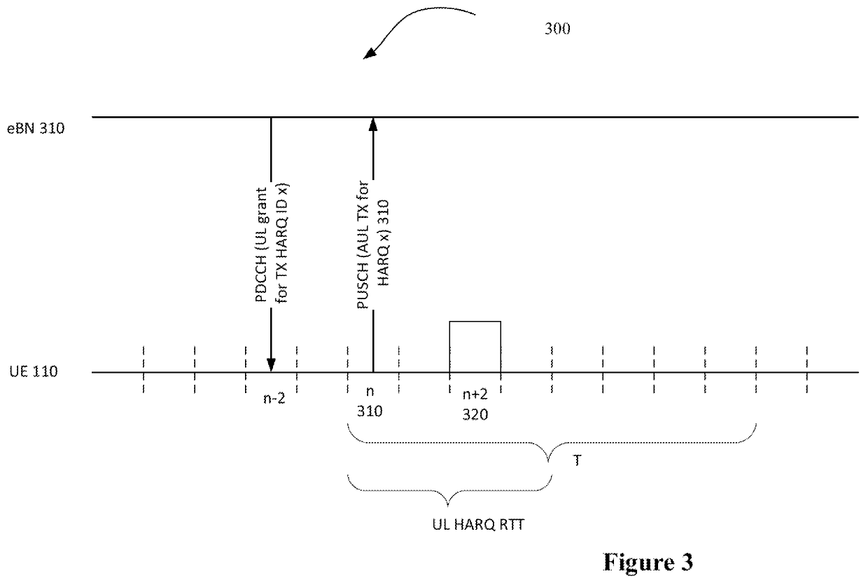

In one embodiment, the UE will refrain from performing a transmission from a certain HARQ process for a certain time or time period T, after the UE has performed a transmission from this HARQ process, or as it will be referred to herein, that the UE refrains from performing an early subsequent transmission. This embodiment 300 is illustrated in FIG. 3. It can be seen that, at time n, the UE 110 performs a transmission of a certain HARQ process ID (step 310). The UE 110 is requested to perform a transmission of the same HARQ process ID at a time n+2 (step 320). Because of the transmission in step 310, the UE does not perform a transmission for the same HARQ process ID, even though a request was received, requesting a transmission at n+2.

In this example, the time T is equal to 8 TTIs and hence the transmission at time n+2 is considered to be an early subsequent transmission. It should be noted that the grant for the early subsequent transmission would not necessarily be received at TTI=n. For example, in the example of FIG. 3, the SUL grant for the early subsequent transmission is received on PDCCH from the eNB at time n−2.

It should be noted that in FIG. 3, the UE has an AUL transmission opportunity before a SUL transmission opportunity.

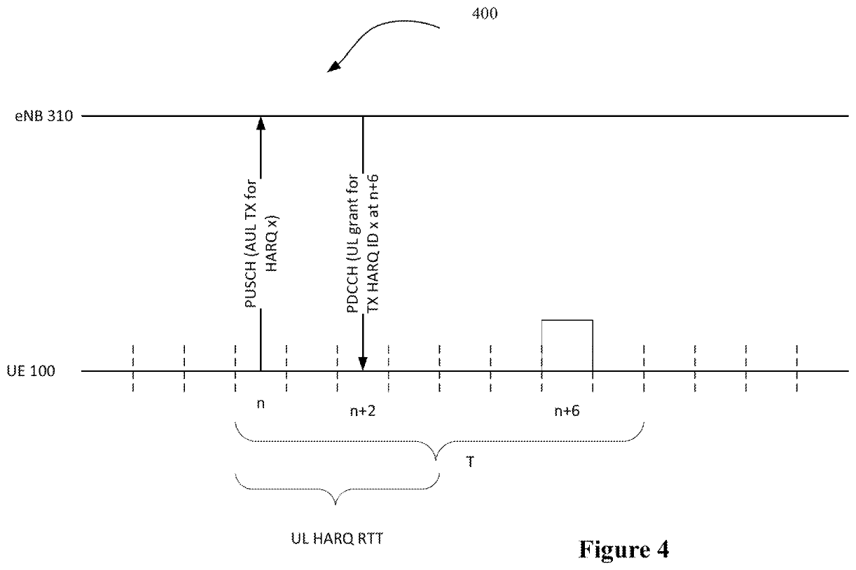

In another example, FIG. 4 illustrates a method 400 for transmitting HARQ messages.

At step 410, the UE performs a first transmission for a HARQ process x. This transmission is done in the AUL mode.

At step 420, a SUL grant for a transmission associated with the HARQ process x is received at time n+2, which is valid for a transmission at n+6. Since 6 is smaller than the time T (which is 8 in this example), such transmission is treated by the UE as an early subsequent transmission. Therefore, the UE refrains from performing the transmission for the HARQ process x at time n+6.

Generally stated, in order to avoid early subsequent transmissions, the UE does not process a grant received for a HARQ process, for which the UE has recently performed a transmission, during the time T. In other embodiments, in order to avoid early subsequent transmissions, the UE can consider the grant invalid or not act upon the grant. Other ways may be envisioned, which can ensure that the UE refrains from performing an early subsequent transmission.

When the eNB detects a PUSCH transmission at time n (see step 410) for the associated HARQ process, the eNB should not schedule UL transmission grants associated with this HARQ process for the UE UL, before the time T expires. It should be noted that the eNB may provide those grants to the UE before the time T expires. However, those grants (given by the eNB) should not be considered valid by the UE before the time T expires.

The time T can be configured by the eNB or it can be a fixed value such that T depends on the length of the UL HARQ RTT.

In one example, T=[(2×UL HARQ RTT)] so that all the UL grants valid for transmission of a certain HARQ process during this period T will be treated as early subsequent transmissions and suppressed by the UE and all the UL grants related to such early subsequent transmission are not processed by the UE.

In another example, the time T is set by the eNB such that it depends on the time the eNB needs to process a PUSCH transmission. In fact, it can happen that since the eNB is not aware of when the UE intends to transmit a certain HARQ process, the eNB schedules transmission for a certain HARQ process before the eNB completes the decoding of the PUSCH transmission. For example, assuming that the eNB needs 1 ms after PUSCH transmission at time n to decode the PUSCH, the first grant that the eNB can send would be at time n+2 for a PUSCH transmission at time n+6. Therefore, the timer T can be set to 6 ms. In this way, the time T configuration guarantees that the grant received by the UE after time n+2 is not spurious, and that all the transmissions granted before time T expires should not be performed since the eNB was certainly not able to decode the PUSCH transmission at time n.

In the previous embodiments, the UE has an AUL transmission opportunity before a SUL transmission opportunity (as shown in FIG. 3). However, embodiments in which the UE has a valid SUL transmission opportunity before an AUL transmission opportunity can be considered (i.e. the reversed order of the SUL and AUL transmission opportunities from the previous embodiments). For example, the UE may have an AUL grant which is valid at time n in a TTI and the UE acquires a SUL grant which is valid earlier (e.g. at time n−1). In this scenario, the transmission associated with the AUL grant would be considered as the “early subsequent transmission”. By applying the embodiments herein, the UE may suppress the transmission associated with the (later) AUL grant. In a special case, the UE can, instead of suppressing the AUL transmission, perform the transmission but for another HARQ process. As such, the UE may perform the SUL transmission at time n−1 and then the UE may perform an AUL transmission at time TTI=n but for another HARQ process. In another special case, the UE can, instead of suppressing the AUL transmission, perform the transmission for the same HARQ process if the MAC PDU associated with this HARQ process is of high priority, e.g. associated with a high priority logical channel.

If the UE suppresses the AUL transmission because it is considered as an early subsequent transmission compared to a SUL transmission, the UE can only do so if the AUL transmission happens within a certain time Y after the SUL transmission. For example, if the AUL transmission is supposed to happen too shortly after the SUL, the UE may not suppress the AUL transmission since that may be complicated from a UE processing point of view. The time Y may depend on network signalling, UE capabilities, processing capacities, etc. And for the special case described above where the UE is transmitting another HARQ process in the AUL transmission opportunity associated with a first HARQ process, it may depend on how quickly the UE can prepare such a transmission. For example, if the AUL transmission happens only one TTI after the SUL transmission, the UE may not be required to transmit from another HARQ process. However, if it is 2 TTIs from the SUL transmission until the AUL transmission, the UE may be required to perform the transmission from another HARQ process.

Conditional Suppressing of Early Subsequent Transmission

The UE may consider some conditions when determining whether or not to suppress early subsequent transmissions. Some example conditions will be described here.

UE Capabilities—

One condition which the UE may consider is the capabilities of the UE. For example, some UEs may be capable of performing an early subsequent transmission while others may not. This would for example depend on the UE capability of preparing an AUL transmission while processing and preparing an early subsequent transmission after the SUL grant reception. Further, how early after a certain transmission the UE is capable of performing the subsequent transmission (value T mentioned above) may be different for different UEs.

Such UE capability might also depend on the priority (e.g. Logical Chanel Identities (LCIDs)) of the data to be transmitted in a given MAC Packet Data Unit (PDU). For example, if the HARQ process is related to a transmission of important data (which may be defined by a priority associated with the bearer the data in the transmission belongs to) the UE may try to prepare a transmission of AUL at time n and the early subsequent transmission before time T expires. In another example, such operation will only be performed if both the AUL and the early subsequent transmission are retransmissions of the same HARQ process ID or new transmission of the same HARQ process ID. If the AUL is referring to a retransmission and the early subsequent transmission to a new transmission of the same HARQ process ID (or vice versa), the UE will only perform the retransmission and not process the grant for the early subsequent transmission. In yet another example, if both the AUL and the early subsequent transmission are retransmissions of the same HARQ process ID, the UE performs both transmissions only if the redundancy version (RVI) is the same or respects a certain specified order (e.g. AUL transmission at time n has RVI=2, and the PDCCH for the early subsequent transmission at time n+2 indicates RVI=3).

Network Indication—

The UE may consider an indication received from the network (e.g. eNB) as to whether the UE shall suppress the early subsequent transmission or not. This indication may be provided together with, or in, a grant which the UE receives such as in a DCI indication. This has the benefit that the network can decide per grant whether the UE should suppress an early subsequent transmission or not.

Configuration of the UE—

The UE may be configured, e.g. by means of RRC signalling, whether the UE shall suppress early subsequent transmissions or not. Further the network (e.g. eNB) may indicate the time T, i.e. the network may configure the UE to suppress a subsequent transmission which should happen a time T after the previous transmission, while transmissions which should happen after this configured time T shall not be suppressed. This configuration may be configured per serving cell of the UE. Another alternative is that it can be configured together with a configuration of grants, such as configured together with a Semi-Persistent Scheduling configuration, whether the UE should do this and a time T which the UE should consider.

Properties of the Early Subsequent Transmission—

The UE may decide whether or not to suppress a transmission depending on if the transmission is a retransmission or if it is a new transmission. For example, if the UE performs a transmission of a certain transmission block at TTI=n, and the UE has acquired a grant to perform a new transmission at time n+2, then the UE may suppress this transmission since it is a new transmission. However, if, on the other hand, the grant is to perform a retransmission, the UE may perform (hence not suppress) the early subsequent transmission. Another property of the early subsequent transmission which the UE may consider is whether a different redundancy version is to be used for the early subsequent transmission.

Success or Failure of Transmissions—

The UE may conditionally suppress an early subsequent transmission based on whether the UE successfully performed the previous transmission. For example, in the example of FIG. 3, if the UE intended to perform a transmission at time n, and has acquired a grant for the same HARQ process at time n+2, then the UE may perform the transmission depending on whether the UE successfully performed the transmission at time n. If for example an LBT procedure resulted in that the UE did not perform the transmission at time n, then the UE may decide to perform the transmission at n+2, while if the UE actually performed the transmission at time n, then the UE may suppress the early subsequent transmission at time n+2.

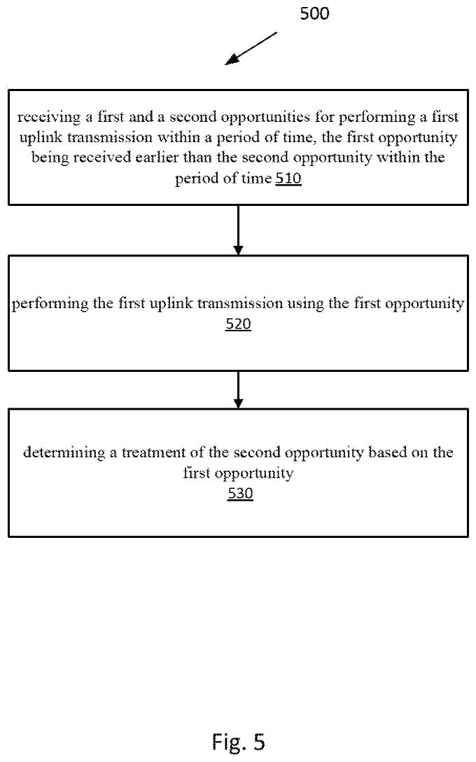

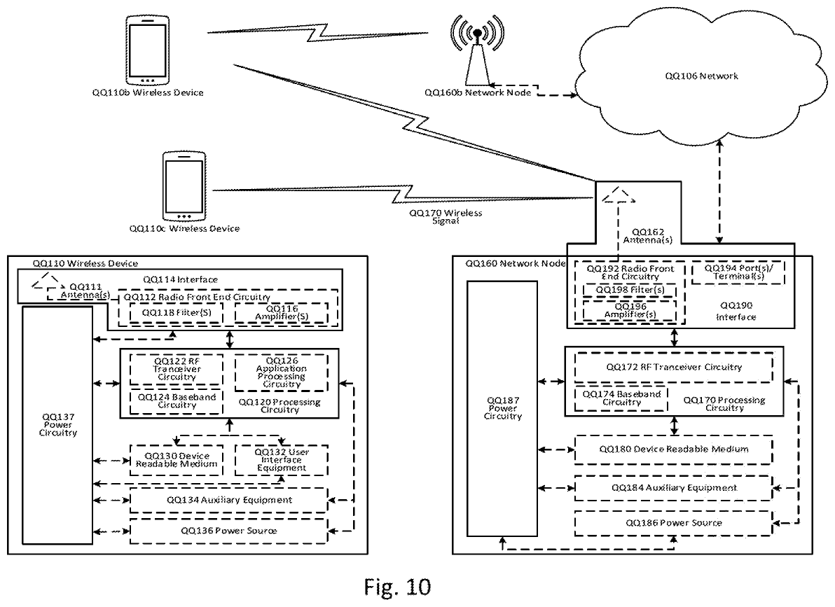

FIG. 5 illustrates a flow chart of a method 500 in a wireless device for LAA, according to an embodiment. The wireless device could be the wireless device 110 or QQ110 of FIG. 10.

The method 500 comprises:

Step 510: receiving a first and a second opportunities for performing a first uplink transmission within a period of time, the first opportunity being received earlier than the second opportunity within the period of time.

Step 520: performing the first uplink transmission using the first opportunity.

Step 530: determining a treatment of the second opportunity based on the first opportunity.

In some embodiments [copy dependent claims here]

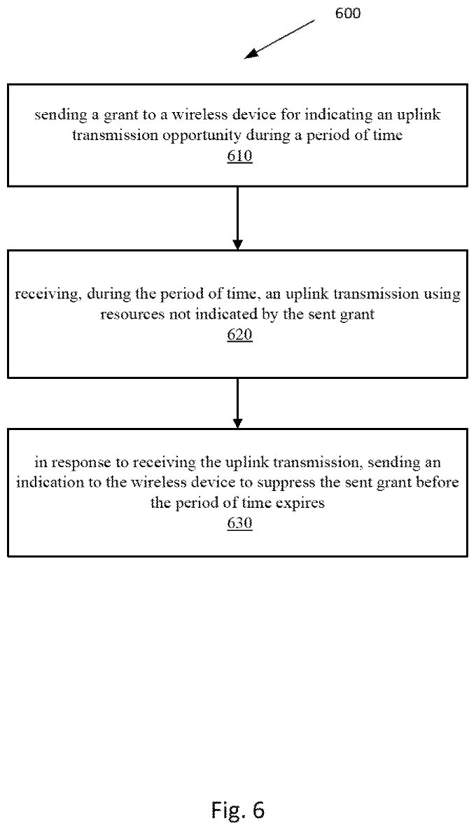

FIG. 6 illustrates a flow chart of a method 600 in a network node for LAA, according to an embodiment. An example of the network node is QQ160 of FIG. 10.

The method 600 comprises:

Step 610: sending a grant to a wireless device for indicating an uplink transmission opportunity during a period of time.

Step 620: receiving, during the period of time, an uplink transmission using resources not indicated by the sent grant.

Step 630: in response to receiving the uplink transmission, sending an indication to the wireless device to suppress the sent grant before the period of time expires.

In some embodiments, the method 600 (or the network node) may further configure the period of time based on the time that the network node needs to process uplink transmissions.

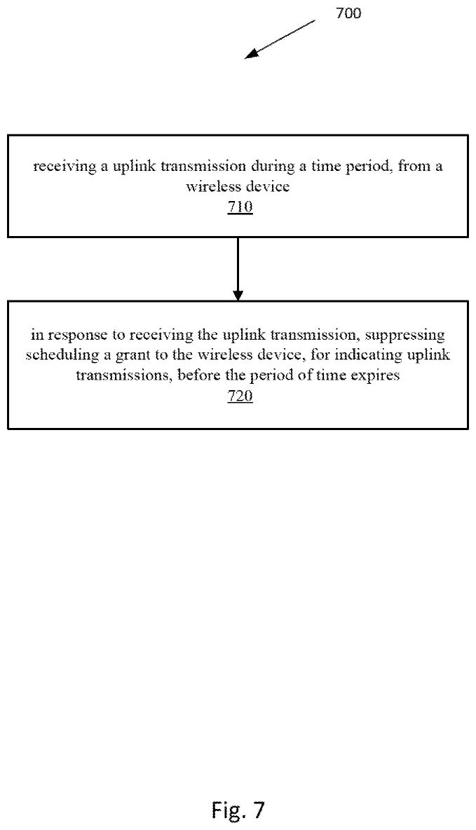

FIG. 7 illustrates a flow chart of a method 700 in a network node for LAA, according to an embodiment. An example of the network node is QQ160 of FIG. 10.

The method 700 comprises:

Step 710: receiving a uplink transmission during a time period, from a wireless device.

Step 720: in response to receiving the uplink transmission, suppressing scheduling a grant to the wireless device, for indicating uplink transmissions, before the period of time expires.

FIG. 8 illustrates a schematic block diagram of a wireless device 110 according to an embodiment. The wireless device 110 includes one or more modules 800, each of which is implemented in software. The module(s) 800 provide the functionality of the wireless device 110 described herein. The module(s) 800 may comprise, for example, a receiving module operable to perform step 510 of FIG. 5, a performing module operable to perform step 520 of FIG. 5 and a determining module operable to perform step 530 of FIG. 5.

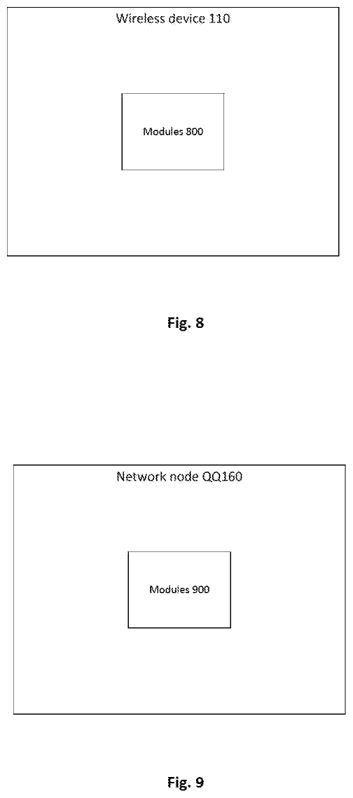

FIG. 9 illustrates a schematic block diagram of a network node QQ160 (as described with reference to FIG. 10), according to an embodiment.

The wireless device 110 includes one or more modules 900, each of which is implemented in software. The module(s) 900 provide the functionality of the network node 110 described herein. The module(s) 900 may comprise, for example, a receiving module operable to perform step 710 of FIG. 7 and step 620 of FIG. 6, a suppressing module operable to perform step 720 of FIG. 7, and a sending module operable to perform steps 610 and 630 of FIG. 6.

Although the subject matter described herein may be implemented in any appropriate type of system using any suitable components, the embodiments disclosed herein are described in relation to a wireless network, such as the example wireless network illustrated in FIG. 10. For simplicity, the wireless network of FIG. 10 only depicts network QQ106, network nodes QQ160 and QQ160b, and WDs QQ110, QQ110b, and QQ110c, which are equivalent to wireless device 110. In practice, a wireless network may further include any additional elements suitable to support communication between wireless devices or between a wireless device and another communication device, such as a landline telephone, a service provider, or any other network node or end device. Of the illustrated components, network node QQ160 and wireless device (WD) QQ110 (or WD 110) are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network QQ106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node QQ160 and WD QQ110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 10, network node QQ160 includes processing circuitry QQ170, device readable medium QQ180, interface QQ190, auxiliary equipment QQ184, power source QQ186, power circuitry QQ187, and antenna QQ162. Although network node QQ160 illustrated in the example wireless network of FIG. 10 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node QQ160 are depicted as single boxes located within a larger box, or nested within multiple boxes, in practice, a network node may comprise multiple different physical components that make up a single illustrated component (e.g., device readable medium QQ180 may comprise multiple separate hard drives as well as multiple RAM modules).

Similarly, network node QQ160 may be composed of multiple physically separate components (e.g., a NodeB component and a RNC component, or a BTS component and a BSC component, etc.), which may each have their own respective components. In certain scenarios in which network node QQ160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node QQ160 may be configured to support multiple radio access technologies (RATs). In such embodiments, some components may be duplicated (e.g., separate device readable medium QQ180 for the different RATs) and some components may be reused (e.g., the same antenna QQ162 may be shared by the RATs). Network node QQ160 may also include multiple sets of the various illustrated components for different wireless technologies integrated into network node QQ160, such as, for example, GSM, WCDMA, LTE, NR, WiFi, or Bluetooth wireless technologies. These wireless technologies may be integrated into the same or different chip or set of chips and other components within network node QQ160.

Processing circuitry QQ170 is configured to perform any determining, calculating, or similar operations (e.g., certain obtaining operations) described herein as being provided by a network node. These operations performed by processing circuitry QQ170 may include processing information obtained by processing circuitry QQ170 by, for example, converting the obtained information into other information, comparing the obtained information or converted information to information stored in the network node, and/or performing one or more operations based on the obtained information or converted information, and as a result of said processing making a determination. For example, processing circuitry QQ170 is configured to perform any of the steps of methods 600 and 700 of FIG. 6 and FIG. 7 respectively.

Processing circuitry QQ170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node QQ160 components, such as device readable medium QQ180, network node QQ160 functionality. For example, processing circuitry QQ170 may execute instructions stored in device readable medium QQ180 or in memory within processing circuitry QQ170. Such functionality may include providing any of the various wireless features, functions, or benefits discussed herein. In some embodiments, processing circuitry QQ170 may include a system on a chip (SOC).

In some embodiments, processing circuitry QQ170 may include one or more of radio frequency (RF) transceiver circuitry QQ172 and baseband processing circuitry QQ174. In some embodiments, radio frequency (RF) transceiver circuitry QQ172 and baseband processing circuitry QQ174 may be on separate chips (or sets of chips), boards, or units, such as radio units and digital units. In alternative embodiments, part or all of RF transceiver circuitry QQ172 and baseband processing circuitry QQ174 may be on the same chip or set of chips, boards, or units

In certain embodiments, some or all of the functionality described herein (such as method 600) as being provided by a network node, base station, eNB or other such network device may be performed by processing circuitry QQ170 executing instructions stored on device readable medium QQ180 or memory within processing circuitry QQ170. In alternative embodiments, some or all of the functionality may be provided by processing circuitry QQ170 without executing instructions stored on a separate or discrete device readable medium, such as in a hard-wired manner. In any of those embodiments, whether executing instructions stored on a device readable storage medium or not, processing circuitry QQ170 can be configured to perform the described functionality. The benefits provided by such functionality are not limited to processing circuitry QQ170 alone or to other components of network node QQ160, but are enjoyed by network node QQ160 as a whole, and/or by end users and the wireless network generally.

Device readable medium QQ180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry QQ170. Device readable medium QQ180 may store any suitable instructions, data or information, including a computer program, software, an application including one or more of logic, rules, code, tables, etc. and/or other instructions capable of being executed by processing circuitry QQ170 and, utilized by network node QQ160. Device readable medium QQ180 may be used to store any calculations made by processing circuitry QQ170 and/or any data received via interface QQ190. In some embodiments, processing circuitry QQ170 and device readable medium QQ180 may be considered to be integrated.

Interface QQ190 is used in the wired or wireless communication of signalling and/or data between network node QQ160, network QQ106, and/or WDs QQ110. As illustrated, interface QQ190 comprises port(s)/terminal(s) QQ194 to send and receive data, for example to and from network QQ106 over a wired connection. Interface QQ190 also includes radio front end circuitry QQ192 that may be coupled to, or in certain embodiments a part of, antenna QQ162. Radio front end circuitry QQ192 comprises filters QQ198 and amplifiers QQ196. Radio front end circuitry QQ192 may be connected to antenna QQ162 and processing circuitry QQ170. Radio front end circuitry may be configured to condition signals communicated between antenna QQ162 and processing circuitry QQ170. Radio front end circuitry QQ192 may receive digital data that is to be sent out to other network nodes or WDs via a wireless connection. Radio front end circuitry QQ192 may convert the digital data into a radio signal having the appropriate channel and bandwidth parameters using a combination of filters QQ198 and/or amplifiers QQ196. The radio signal may then be transmitted via antenna QQ162. Similarly, when receiving data, antenna QQ162 may collect radio signals which are then converted into digital data by radio front end circuitry QQ192. The digital data may be passed to processing circuitry QQ170. In other embodiments, the interface may comprise different components and/or different combinations of components.

In certain alternative embodiments, network node QQ160 may not include separate radio front end circuitry QQ192, instead, processing circuitry QQ170 may comprise radio front end circuitry and may be connected to antenna QQ162 without separate radio front end circuitry QQ192. Similarly, in some embodiments, all or some of RF transceiver circuitry QQ172 may be considered a part of interface QQ190. In still other embodiments, interface QQ190 may include one or more ports or terminals QQ194, radio front end circuitry QQ192, and RF transceiver circuitry QQ172, as part of a radio unit (not shown), and interface QQ190 may communicate with baseband processing circuitry QQ174, which is part of a digital unit (not shown).

Antenna QQ162 may include one or more antennas, or antenna arrays, configured to send and/or receive wireless signals. Antenna QQ162 may be coupled to radio front end circuitry QQ190 and may be any type of antenna capable of transmitting and receiving data and/or signals wirelessly. In some embodiments, antenna QQ162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna QQ162 may be separate from network node QQ160 and may be connectable to network node QQ160 through an interface or port.

Antenna QQ162, interface QQ190, and/or processing circuitry QQ170 may be configured to perform any receiving operations and/or certain obtaining operations described herein as being performed by a network node. Any information, data and/or signals may be received from a wireless device, another network node and/or any other network equipment. Similarly, antenna QQ162, interface QQ190, and/or processing circuitry QQ170 may be configured to perform any transmitting operations described herein as being performed by a network node. Any information, data and/or signals may be transmitted to a wireless device, another network node and/or any other network equipment.

Power circuitry QQ187 may comprise, or be coupled to, power management circuitry and is configured to supply the components of network node QQ160 with power for performing the functionality described herein. Power circuitry QQ187 may receive power from power source QQ186. Power source QQ186 and/or power circuitry QQ187 may be configured to provide power to the various components of network node QQ160 in a form suitable for the respective components (e.g., at a voltage and current level needed for each respective component). Power source QQ186 may either be included in, or external to, power circuitry QQ187 and/or network node QQ160. For example, network node QQ160 may be connectable to an external power source (e.g., an electricity outlet) via an input circuitry or interface such as an electrical cable, whereby the external power source supplies power to power circuitry QQ187. As a further example, power source QQ186 may comprise a source of power in the form of a battery or battery pack which is connected to, or integrated in, power circuitry QQ187. The battery may provide backup power should the external power source fail. Other types of power sources, such as photovoltaic devices, may also be used.

Alternative embodiments of network node QQ160 may include additional components beyond those shown in FIG. 10 that may be responsible for providing certain aspects of the network node's functionality, including any of the functionality described herein and/or any functionality necessary to support the subject matter described herein. For example, network node QQ160 may include user interface equipment to allow input of information into network node QQ160 and to allow output of information from network node QQ160. This may allow a user to perform diagnostic, maintenance, repair, and other administrative functions for network node QQ160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device QQ110 includes antenna QQ111, interface QQ114, processing circuitry QQ120, device readable medium QQ130, user interface equipment QQ132, auxiliary equipment QQ134, power source QQ136 and power circuitry QQ137. WD QQ110 may include multiple sets of one or more of the illustrated components for different wireless technologies supported by WD QQ110, such as, for example, GSM, WCDMA, LTE, NR, WiFi, WiMAX, or Bluetooth wireless technologies, just to mention a few. These wireless technologies may be integrated into the same or different chips or set of chips as other components within WD QQ110.

Antenna QQ111 may include one or more antennas or antenna arrays, configured to send and/or receive wireless signals, and is connected to interface QQ114. In certain alternative embodiments, antenna QQ111 may be separate from WD QQ110 and be connectable to WD QQ110 through an interface or port. Antenna QQ111, interface QQ114, and/or processing circuitry QQ120 may be configured to perform any receiving or transmitting operations described herein as being performed by a WD. Any information, data and/or signals may be received from a network node and/or another WD. In some embodiments, radio front end circuitry and/or antenna QQ111 may be considered an interface.

As illustrated, interface QQ114 comprises radio front end circuitry QQ112 and antenna QQ111. Radio front end circuitry QQ112 comprise one or more filters QQ118 and amplifiers QQ116. Radio front end circuitry QQ114 is connected to antenna QQ111 and processing circuitry QQ120, and is configured to condition signals communicated between antenna QQ111 and processing circuitry QQ120. Radio front end circuitry QQ112 may be coupled to or a part of antenna QQ111. In some embodiments, WD QQ110 may not include separate radio front end circuitry QQ112; rather, processing circuitry QQ120 may comprise radio front end circuitry and may be connected to antenna QQ111. Similarly, in some embodiments, some or all of RF transceiver circuitry QQ122 may be considered a part of interface QQ114. Radio front end circuitry QQ112 may receive digital data that is to be sent out to other network nodes or WDs via a wireless connection. Radio front end circuitry QQ112 may convert the digital data into a radio signal having the appropriate channel and bandwidth parameters using a combination of filters QQ118 and/or amplifiers QQ116. The radio signal may then be transmitted via antenna QQ111. Similarly, when receiving data, antenna QQ111 may collect radio signals which are then converted into digital data by radio front end circuitry QQ112. The digital data may be passed to processing circuitry QQ120. In other embodiments, the interface may comprise different components and/or different combinations of components.

Processing circuitry QQ120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD QQ110 components, such as device readable medium QQ130, WD QQ110 functionality. Such functionality may include providing any of the various wireless features or benefits discussed herein. For example, processing circuitry QQ120 may execute instructions stored in device readable medium QQ130 or in memory within processing circuitry QQ120 to provide the functionality disclosed herein. For example, processing circuitry QQ120 is configured to perform any of the steps of method 500 of FIG. 5.

As illustrated, processing circuitry QQ120 includes one or more of RF transceiver circuitry QQ122, baseband processing circuitry QQ124, and application processing circuitry QQ126. In other embodiments, the processing circuitry may comprise different components and/or different combinations of components. In certain embodiments processing circuitry QQ120 of WD QQ110 may comprise a SOC. In some embodiments, RF transceiver circuitry QQ122, baseband processing circuitry QQ124, and application processing circuitry QQ126 may be on separate chips or sets of chips. In alternative embodiments, part or all of baseband processing circuitry QQ124 and application processing circuitry QQ126 may be combined into one chip or set of chips, and RF transceiver circuitry QQ122 may be on a separate chip or set of chips. In still alternative embodiments, part or all of RF transceiver circuitry QQ122 and baseband processing circuitry QQ124 may be on the same chip or set of chips, and application processing circuitry QQ126 may be on a separate chip or set of chips. In yet other alternative embodiments, part or all of RF transceiver circuitry QQ122, baseband processing circuitry QQ124, and application processing circuitry QQ126 may be combined in the same chip or set of chips. In some embodiments, RF transceiver circuitry QQ122 may be a part of interface QQ114. RF transceiver circuitry QQ122 may condition RF signals for processing circuitry QQ120.

In certain embodiments, some or all of the functionality described (such as method 500) herein as being performed by a WD may be provided by processing circuitry QQ120 executing instructions stored on device readable medium QQ130, which in certain embodiments may be a computer-readable storage medium. In alternative embodiments, some or all of the functionality may be provided by processing circuitry QQ120 without executing instructions stored on a separate or discrete device readable storage medium, such as in a hard-wired manner. In any of those particular embodiments, whether executing instructions stored on a device readable storage medium or not, processing circuitry QQ120 can be configured to perform the described functionality. The benefits provided by such functionality are not limited to processing circuitry QQ120 alone or to other components of WD QQ110, but are enjoyed by WD QQ110 as a whole, and/or by end users and the wireless network generally.

Processing circuitry QQ120 may be configured to perform any determining, calculating, or similar operations (e.g., certain obtaining operations) described herein as being performed by a WD. These operations, as performed by processing circuitry QQ120, may include processing information obtained by processing circuitry QQ120 by, for example, converting the obtained information into other information, comparing the obtained information or converted information to information stored by WD QQ110, and/or performing one or more operations based on the obtained information or converted information, and as a result of said processing making a determination.

Device readable medium QQ130 may be operable to store a computer program, software, an application including one or more of logic, rules, code, tables, etc. and/or other instructions capable of being executed by processing circuitry QQ120. Device readable medium QQ130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry QQ120. In some embodiments, processing circuitry QQ120 and device readable medium QQ130 may be considered to be integrated.

User interface equipment QQ132 may provide components that allow for a human user to interact with WD QQ110. Such interaction may be of many forms, such as visual, audial, tactile, etc. User interface equipment QQ132 may be operable to produce output to the user and to allow the user to provide input to WD QQ110. The type of interaction may vary depending on the type of user interface equipment QQ132 installed in WD QQ110. For example, if WD QQ110 is a smart phone, the interaction may be via a touch screen; if WD QQ110 is a smart meter, the interaction may be through a screen that provides usage (e.g., the number of gallons used) or a speaker that provides an audible alert (e.g., if smoke is detected). User interface equipment QQ132 may include input interfaces, devices and circuits, and output interfaces, devices and circuits. User interface equipment QQ132 is configured to allow input of information into WD QQ110, and is connected to processing circuitry QQ120 to allow processing circuitry QQ120 to process the input information. User interface equipment QQ132 may include, for example, a microphone, a proximity or other sensor, keys/buttons, a touch display, one or more cameras, a USB port, or other input circuitry. User interface equipment QQ132 is also configured to allow output of information from WD QQ110, and to allow processing circuitry QQ120 to output information from WD QQ110. User interface equipment QQ132 may include, for example, a speaker, a display, vibrating circuitry, a USB port, a headphone interface, or other output circuitry. Using one or more input and output interfaces, devices, and circuits, of user interface equipment QQ132, WD QQ110 may communicate with end users and/or the wireless network, and allow them to benefit from the functionality described herein.

Auxiliary equipment QQ134 is operable to provide more specific functionality which may not be generally performed by WDs. This may comprise specialized sensors for doing measurements for various purposes, interfaces for additional types of communication such as wired communications etc. The inclusion and type of components of auxiliary equipment QQ134 may vary depending on the embodiment and/or scenario.

Power source QQ136 may, in some embodiments, be in the form of a battery or battery pack. Other types of power sources, such as an external power source (e.g., an electricity outlet), photovoltaic devices or power cells, may also be used. WD QQ110 may further comprise power circuitry QQ137 for delivering power from power source QQ136 to the various parts of WD QQ110 which need power from power source QQ136 to carry out any functionality described or indicated herein. Power circuitry QQ137 may in certain embodiments comprise power management circuitry. Power circuitry QQ137 may additionally or alternatively be operable to receive power from an external power source; in which case WD QQ110 may be connectable to the external power source (such as an electricity outlet) via input circuitry or an interface such as an electrical power cable. Power circuitry QQ137 may also in certain embodiments be operable to deliver power from an external power source to power source QQ136. This may be, for example, for the charging of power source QQ136. Power circuitry QQ137 may perform any formatting, converting, or other modification to the power from power source QQ136 to make the power suitable for the respective components of WD QQ110 to which power is supplied.

FIG. 8 illustrates one embodiment of a UE in accordance with various aspects described herein. The UE can be the wireless device QQ110 of FIG. 7. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE QQ2200 may be any UE identified by the 3^{rd} Generation Partnership Project (3GPP), including a NB-IoT UE, a machine type communication (MTC) UE, and/or an enhanced MTC (eMTC) UE. UE QQ200, as illustrated in FIG. 8, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although Figure QQ2 is a UE, the components discussed herein are equally applicable to a WD, and vice-versa.

In FIG. 8, UE QQ200 includes processing circuitry QQ201 that is operatively coupled to input/output interface QQ205, radio frequency (RF) interface QQ209, network connection interface QQ211, memory QQ215 including random access memory (RAM) QQ217, read-only memory (ROM) QQ219, and storage medium QQ221 or the like, communication subsystem QQ231, power source QQ233, and/or any other component, or any combination thereof. Storage medium QQ221 includes operating system QQ223, application program QQ225, and data QQ227. In other embodiments, storage medium QQ221 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry QQ201 may be configured to process computer instructions and data. Processing circuitry QQ201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry QQ201 may include two central processing units (CPUs). Data may be information in a form suitable for use by a computer.

In the depicted embodiment, input/output interface QQ205 may be configured to provide a communication interface to an input device, output device, or input and output device. UE QQ200 may be configured to use an output device via input/output interface QQ205. An output device may use the same type of interface port as an input device. For example, a USB port may be used to provide input to and output from UE QQ200. The output device may be a speaker, a sound card, a video card, a display, a monitor, a printer, an actuator, an emitter, a smartcard, another output device, or any combination thereof. UE QQ200 may be configured to use an input device via input/output interface QQ205 to allow a user to capture information into UE QQ200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface QQ209 may be configured to provide a communication interface to RF components such as a transmitter, a receiver, and an antenna. Network connection interface QQ211 may be configured to provide a communication interface to network QQ243a. Network QQ243a may encompass wired and/or wireless networks such as a local-area network (LAN), a wide-area network (WAN), a computer network, a wireless network, a telecommunications network, another like network or any combination thereof. For example, network QQ243a may comprise a Wi-Fi network. Network connection interface QQ211 may be configured to include a receiver and a transmitter interface used to communicate with one or more other devices over a communication network according to one or more communication protocols, such as Ethernet, TCP/IP, SONET, ATM, or the like. Network connection interface QQ211 may implement receiver and transmitter functionality appropriate to the communication network links (e.g., optical, electrical, and the like). The transmitter and receiver functions may share circuit components, software or firmware, or alternatively may be implemented separately.

RAM QQ217 may be configured to interface via bus QQ202 to processing circuitry QQ201 to provide storage or caching of data or computer instructions during the execution of software programs such as the operating system, application programs, and device drivers. ROM QQ219 may be configured to provide computer instructions or data to processing circuitry QQ201. For example, ROM QQ219 may be configured to store invariant low-level system code or data for basic system functions such as basic input and output (I/O), startup, or reception of keystrokes from a keyboard that are stored in a non-volatile memory. Storage medium QQ221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium QQ221 may be configured to include operating system QQ223, application program QQ225 such as a web browser application, a widget or gadget engine or another application, and data file QQ227. Storage medium QQ221 may store, for use by UE QQ200, any of a variety of various operating systems or combinations of operating systems.

Storage medium QQ221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium QQ221 may allow UE QQ200 to access computer-executable instructions, application programs or the like, stored on transitory or non-transitory memory media, to off-load data, or to upload data. An article of manufacture, such as one utilizing a communication system may be tangibly embodied in storage medium QQ221, which may comprise a device readable medium.

In FIG. 8, processing circuitry QQ201 may be configured to communicate with network QQ243b using communication subsystem QQ231. Network QQ243a and network QQ243b may be the same network or networks or different network or networks. Communication subsystem QQ231 may be configured to include one or more transceivers used to communicate with network QQ243b. For example, communication subsystem QQ231 may be configured to include one or more transceivers used to communicate with one or more remote transceivers of another device capable of wireless communication such as another WD, UE, or base station of a radio access network (RAN) according to one or more communication protocols, such as IEEE 802. QQ2, CDMA, WCDMA, GSM, LTE, UTRAN, WiMax, or the like. Each transceiver may include transmitter QQ233 and/or receiver QQ235 to implement transmitter or receiver functionality, respectively, appropriate to the RAN links (e.g., frequency allocations and the like). Further, transmitter QQ233 and receiver QQ235 of each transceiver may share circuit components, software or firmware, or alternatively may be implemented separately.

In the illustrated embodiment, the communication functions of communication subsystem QQ231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem QQ231 may include cellular communication, Wi-Fi communication, Bluetooth communication, and GPS communication. Network QQ243b may encompass wired and/or wireless networks such as a local-area network (LAN), a wide-area network (WAN), a computer network, a wireless network, a telecommunications network, another like network or any combination thereof. For example, network QQ243b may be a cellular network, a Wi-Fi network, and/or a near-field network. Power source QQ213 may be configured to provide alternating current (AC) or direct current (DC) power to components of UE QQ200.

The features, benefits and/or functions described herein may be implemented in one of the components of UE QQ200 or partitioned across multiple components of UE QQ200. Further, the features, benefits, and/or functions described herein may be implemented in any combination of hardware, software or firmware. In one example, communication subsystem QQ231 may be configured to include any of the components described herein. Further, processing circuitry QQ201 may be configured to communicate with any of such components over bus QQ202. In another example, any of such components may be represented by program instructions stored in memory that when executed by processing circuitry QQ201 perform the corresponding functions described herein. In another example, the functionality of any of such components may be partitioned between processing circuitry QQ201 and communication subsystem QQ231. In another example, the non-computationally intensive functions of any of such components may be implemented in software or firmware and the computationally intensive functions may be implemented in hardware.

FIG. 9 is a schematic block diagram illustrating a virtualization environment QQ300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments QQ300 hosted by one or more of hardware nodes QQ330. Further, in embodiments in which the virtual node is not a radio access node or does not require radio connectivity (e.g., a core network node), then the network node may be entirely virtualized.

The functions may be implemented by one or more applications QQ320 (which may alternatively be called software instances, virtual appliances, network functions, virtual nodes, virtual network functions, etc.) operative to implement some of the features, functions, and/or benefits of some of the embodiments disclosed herein. Applications QQ320 are run in virtualization environment QQ300 which provides hardware QQ330 comprising processing circuitry QQ360 and memory QQ390. Memory QQ390 contains instructions QQ395 executable by processing circuitry QQ360 whereby application QQ320 is operative to provide one or more of the features, benefits, and/or functions disclosed herein.

Virtualization environment QQ300, comprises general-purpose or special-purpose network hardware devices QQ330 comprising a set of one or more processors or processing circuitry QQ360, which may be commercial off-the-shelf (COTS) processors, dedicated Application Specific Integrated Circuits (ASICs), or any other type of processing circuitry including digital or analog hardware components or special purpose processors. Each hardware device may comprise memory QQ390-1 which may be non-persistent memory for temporarily storing instructions QQ395 or software executed by processing circuitry QQ360. Each hardware device may comprise one or more network interface controllers (NICs) QQ370, also known as network interface cards, which include physical network interface QQ380. Each hardware device may also include non-transitory, persistent, machine-readable storage media QQ390-2 having stored therein software QQ395 and/or instructions executable by processing circuitry QQ360. Software QQ395 may include any type of software including software for instantiating one or more virtualization layers QQ350 (also referred to as hypervisors), software to execute virtual machines QQ340 as well as software allowing it to execute functions, features and/or benefits described in relation with some embodiments described herein.

Virtual machines QQ340, comprise virtual processing, virtual memory, virtual networking or interface and virtual storage, and may be run by a corresponding virtualization layer QQ350 or hypervisor. Different embodiments of the instance of virtual appliance QQ320 may be implemented on one or more of virtual machines QQ340, and the implementations may be made in different ways.

During operation, processing circuitry QQ360 executes software QQ395 to instantiate the hypervisor or virtualization layer QQ350, which may sometimes be referred to as a virtual machine monitor (VMM). Virtualization layer QQ350 may present a virtual operating platform that appears like networking hardware to virtual machine QQ340.

As shown in FIG. 9, hardware QQ330 may be a standalone network node with generic or specific components. Hardware QQ330 may comprise antenna QQ3225 and may implement some functions via virtualization. Alternatively, hardware QQ330 may be part of a larger cluster of hardware (e.g. such as in a data center or customer premise equipment (CPE)) where many hardware nodes work together and are managed via management and orchestration (MANO) QQ3100, which, among others, oversees lifecycle management of applications QQ320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine QQ340 may be a software implementation of a physical machine that runs programs as if they were executing on a physical, non-virtualized machine. Each of virtual machines QQ340, and that part of hardware QQ330 that executes that virtual machine, be it hardware dedicated to that virtual machine and/or hardware shared by that virtual machine with others of the virtual machines QQ340, forms a separate virtual network elements (VNE).

Still in the context of NFV, Virtual Network Function (VNF) is responsible for handling specific network functions that run in one or more virtual machines QQ340 on top of hardware networking infrastructure QQ330 and corresponds to application QQ320 in FIG. 9.

In some embodiments, one or more radio units QQ3200 that each include one or more transmitters QQ3220 and one or more receivers QQ3210 may be coupled to one or more antennas QQ3225. Radio units QQ3200 may communicate directly with hardware nodes QQ330 via one or more appropriate network interfaces and may be used in combination with the virtual components to provide a virtual node with radio capabilities, such as a radio access node or a base station.

In some embodiments, some signalling can be effected with the use of control system QQ3230 which may alternatively be used for communication between the hardware nodes QQ330 and radio units QQ3200.

With reference to FIG. 10, in accordance with an embodiment, a communication system includes telecommunication network QQ410, such as a 3GPP-type cellular network, which comprises access network QQ411, such as a radio access network, and core network QQ414. Access network QQ411 comprises a plurality of base stations QQ412a, QQ412b, QQ412c, such as NBs, eNBs, gNBs or other types of wireless access points, each defining a corresponding coverage area QQ413a, QQ413b, QQ413c. Each base station QQ412a, QQ412b, QQ412c is connectable to core network QQ414 over a wired or wireless connection QQ415. A first UE QQ491 located in coverage area QQ413c is configured to wirelessly connect to, or be paged by, the corresponding base station QQ412c. A second UE QQ492 in coverage area QQ413a is wirelessly connectable to the corresponding base station QQ412a. While a plurality of UEs QQ491, QQ492 are illustrated in this example, the disclosed embodiments are equally applicable to a situation where a sole UE is in the coverage area or where a sole UE is connecting to the corresponding base station QQ412.

Telecommunication network QQ410 is itself connected to host computer QQ430, which may be embodied in the hardware and/or software of a standalone server, a cloud-implemented server, a distributed server or as processing resources in a server farm. Host computer QQ430 may be under the ownership or control of a service provider, or may be operated by the service provider or on behalf of the service provider. Connections QQ421 and QQ422 between telecommunication network QQ410 and host computer QQ430 may extend directly from core network QQ414 to host computer QQ430 or may go via an optional intermediate network QQ420. Intermediate network QQ420 may be one of, or a combination of more than one of, a public, private or hosted network; intermediate network QQ420, if any, may be a backbone network or the Internet; in particular, intermediate network QQ420 may comprise two or more sub-networks (not shown).

The communication system of FIG. 10 as a whole enables connectivity between the connected UEs QQ491, QQ492 and host computer QQ430. The connectivity may be described as an over-the-top (OTT) connection QQ450. Host computer QQ430 and the connected UEs QQ491, QQ492 are configured to communicate data and/or signaling via OTT connection QQ450, using access network QQ411, core network QQ414, any intermediate network QQ420 and possible further infrastructure (not shown) as intermediaries. OTT connection QQ450 may be transparent in the sense that the participating communication devices through which OTT connection QQ450 passes are unaware of routing of uplink and downlink communications. For example, base station QQ412 may not or need not be informed about the past routing of an incoming downlink communication with data originating from host computer QQ430 to be forwarded (e.g., handed over) to a connected UE QQ491. Similarly, base station QQ412 need not be aware of the future routing of an outgoing uplink communication originating from the UE QQ491 towards the host computer QQ430.

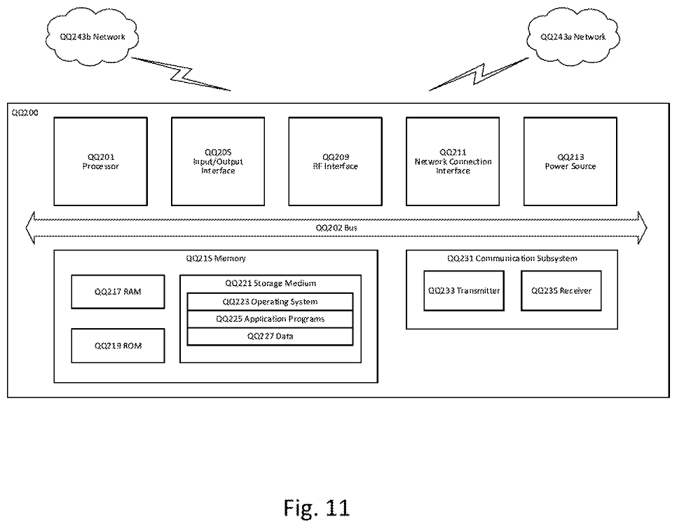

Example implementations, in accordance with an embodiment, of the UE, base station and host computer discussed in the preceding paragraphs will now be described with reference to FIG. 11. In communication system QQ500, host computer QQ510 comprises hardware QQ515 including communication interface QQ516 configured to set up and maintain a wired or wireless connection with an interface of a different communication device of communication system QQ500. Host computer QQ510 further comprises processing circuitry QQ518, which may have storage and/or processing capabilities. In particular, processing circuitry QQ518 may comprise one or more programmable processors, application-specific integrated circuits, field programmable gate arrays or combinations of these (not shown) adapted to execute instructions. Host computer QQ510 further comprises software QQ511, which is stored in or accessible by host computer QQ510 and executable by processing circuitry QQ518. Software QQ511 includes host application QQ512. Host application QQ512 may be operable to provide a service to a remote user, such as UE QQ530 connecting via OTT connection QQ550 terminating at UE QQ530 and host computer QQ510. In providing the service to the remote user, host application QQ512 may provide user data which is transmitted using OTT connection QQ550.

Communication system QQ500 further includes base station QQ520 provided in a telecommunication system and comprising hardware QQ525 enabling it to communicate with host computer QQ510 and with UE QQ530. Hardware QQ525 may include communication interface QQ526 for setting up and maintaining a wired or wireless connection with an interface of a different communication device of communication system QQ500, as well as radio interface QQ527 for setting up and maintaining at least wireless connection QQ570 with UE QQ530 located in a coverage area (not shown in FIG. 11) served by base station QQ520. Communication interface QQ526 may be configured to facilitate connection QQ560 to host computer QQ510. Connection QQ560 may be direct or it may pass through a core network (not shown in FIG. 11) of the telecommunication system and/or through one or more intermediate networks outside the telecommunication system. In the embodiment shown, hardware QQ525 of base station QQ520 further includes processing circuitry QQ528, which may comprise one or more programmable processors, application-specific integrated circuits, field programmable gate arrays or combinations of these (not shown) adapted to execute instructions. Base station QQ520 further has software QQ521 stored internally or accessible via an external connection.

Communication system QQ500 further includes UE QQ530 already referred to. Its hardware QQ535 may include radio interface QQ537 configured to set up and maintain wireless connection QQ570 with a base station serving a coverage area in which UE QQ530 is currently located. Hardware QQ535 of UE QQ530 further includes processing circuitry QQ538, which may comprise one or more programmable processors, application-specific integrated circuits, field programmable gate arrays or combinations of these (not shown) adapted to execute instructions. UE QQ530 further comprises software QQ531, which is stored in or accessible by UE QQ530 and executable by processing circuitry QQ538. Software QQ531 includes client application QQ532. Client application QQ532 may be operable to provide a service to a human or non-human user via UE QQ530, with the support of host computer QQ510. In host computer QQ510, an executing host application QQ512 may communicate with the executing client application QQ532 via OTT connection QQ550 terminating at UE QQ530 and host computer QQ510. In providing the service to the user, client application QQ532 may receive request data from host application QQ512 and provide user data in response to the request data. OTT connection QQ550 may transfer both the request data and the user data. Client application QQ532 may interact with the user to generate the user data that it provides.

It is noted that host computer QQ510, base station QQ520 and UE QQ530 illustrated in FIG. 11 may be similar or identical to host computer QQ430, one of base stations QQ412a, QQ412b, QQ412c and one of UEs QQ491, QQ492 of FIG. 10, respectively. This is to say, the inner workings of these entities may be as shown in FIG. 11 and independently, the surrounding network topology may be that of FIG. 10.

In FIG. 11, OTT connection QQ550 has been drawn abstractly to illustrate the communication between host computer QQ510 and UE QQ530 via base station QQ520, without explicit reference to any intermediary devices and the precise routing of messages via these devices. Network infrastructure may determine the routing, which it may be configured to hide from UE QQ530 or from the service provider operating host computer QQ510, or both. While OTT connection QQ550 is active, the network infrastructure may further take decisions by which it dynamically changes the routing (e.g., on the basis of load balancing consideration or reconfiguration of the network).

Wireless connection QQ570 between UE QQ530 and base station QQ520 is in accordance with the teachings of the embodiments described throughout this disclosure. One or more of the various embodiments improve the performance of OTT services provided to UE QQ530 using OTT connection QQ550, in which wireless connection QQ570 forms the last segment.

A measurement procedure may be provided for the purpose of monitoring data rate, latency and other factors on which the one or more embodiments improve. There may further be an optional network functionality for reconfiguring OTT connection QQ550 between host computer QQ510 and UE QQ530, in response to variations in the measurement results. The measurement procedure and/or the network functionality for reconfiguring OTT connection QQ550 may be implemented in software QQ511 and hardware QQ515 of host computer QQ510 or in software QQ531 and hardware QQ535 of UE QQ530, or both. In embodiments, sensors (not shown) may be deployed in or in association with communication devices through which OTT connection QQ550 passes; the sensors may participate in the measurement procedure by supplying values of the monitored quantities exemplified above, or supplying values of other physical quantities from which software QQ511, QQ531 may compute or estimate the monitored quantities. The reconfiguring of OTT connection QQ550 may include message format, retransmission settings, preferred routing etc.; the reconfiguring need not affect base station QQ520, and it may be unknown or imperceptible to base station QQ520. Such procedures and functionalities may be known and practiced in the art. In certain embodiments, measurements may involve proprietary UE signaling facilitating host computer QQ510's measurements of throughput, propagation times, latency and the like. The measurements may be implemented in that software QQ511 and QQ531 causes messages to be transmitted, in particular empty or ‘dummy’ messages, using OTT connection QQ550 while it monitors propagation times, errors etc.

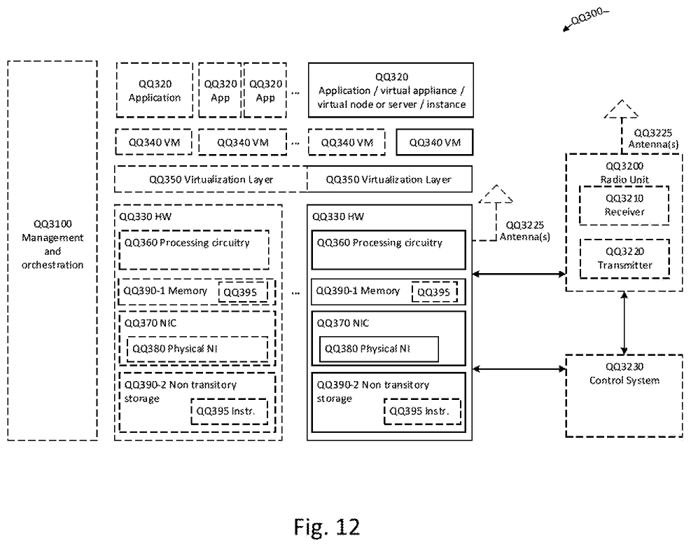

FIG. 12 is a flowchart illustrating a method implemented in a communication system, in accordance with one embodiment. The communication system includes a host computer, a base station and a UE which may be those described with reference to FIGS. QQ4 and QQ5. For simplicity of the present disclosure, only drawing references to FIG. 12 will be included in this section. In step QQ610, the host computer provides user data. In substep QQ611 (which may be optional) of step QQ610, the host computer provides the user data by executing a host application. In step QQ620, the host computer initiates a transmission carrying the user data to the UE. In step QQ630 (which may be optional), the base station transmits to the UE the user data which was carried in the transmission that the host computer initiated, in accordance with the teachings of the embodiments described throughout this disclosure. In step QQ640 (which may also be optional), the UE executes a client application associated with the host application executed by the host computer.

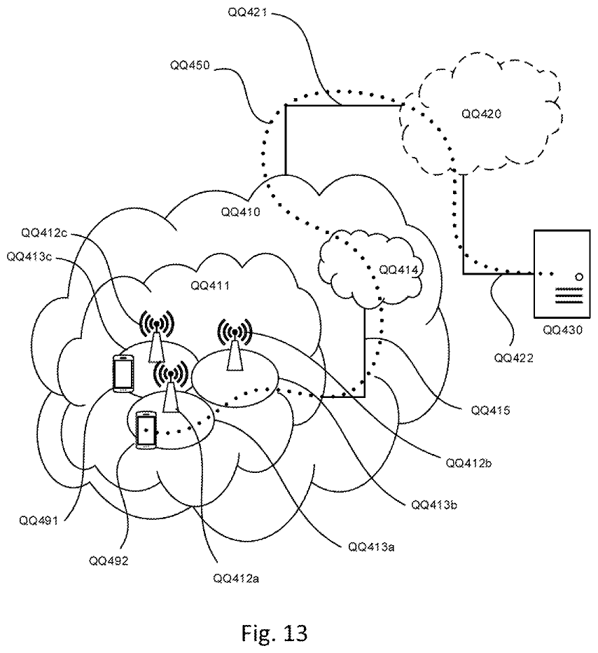

FIG. 13 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 13 will be included in this section. In step QQ710 of the method, the host computer provides user data. In an optional substep (not shown) the host computer provides the user data by executing a host application. In step QQ720, the host computer initiates a transmission carrying the user data to the UE. The transmission may pass via the base station, in accordance with the teachings of the embodiments described throughout this disclosure. In step QQ730 (which may be optional), the UE receives the user data carried in the transmission.

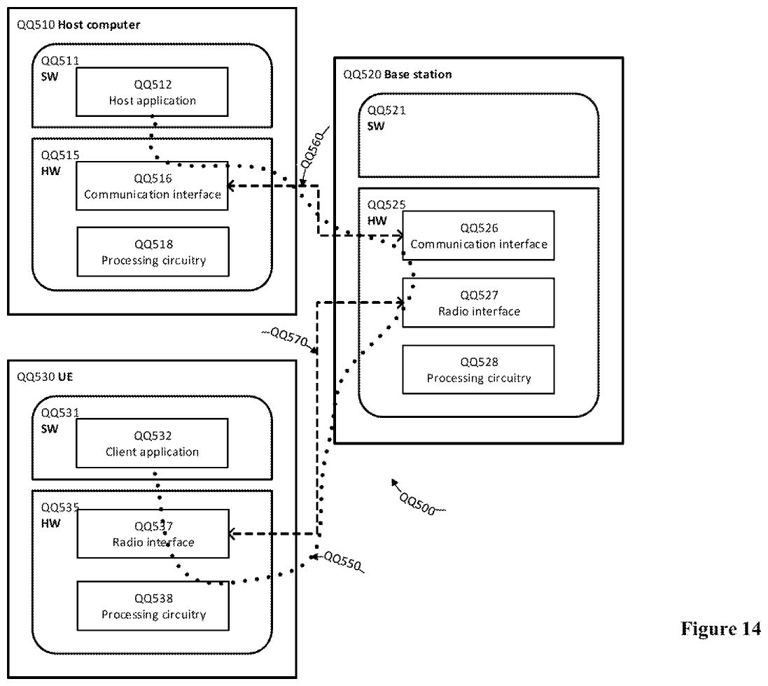

FIG. 14 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 14 will be included in this section. In step QQ810 (which may be optional), the UE receives input data provided by the host computer. Additionally or alternatively, in step QQ820, the UE provides user data. In substep QQ821 (which may be optional) of step QQ820, the UE provides the user data by executing a client application. In substep QQ811 (which may be optional) of step QQ810, the UE executes a client application which provides the user data in reaction to the received input data provided by the host computer. In providing the user data, the executed client application may further consider user input received from the user. Regardless of the specific manner in which the user data was provided, the UE initiates, in substep QQ830 (which may be optional), transmission of the user data to the host computer. In step QQ840 of the method, the host computer receives the user data transmitted from the UE, in accordance with the teachings of the embodiments described throughout this disclosure.

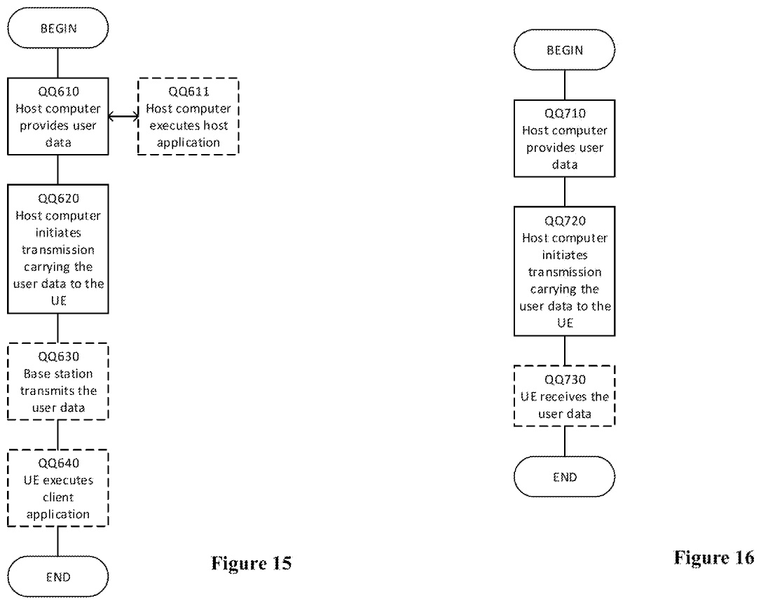

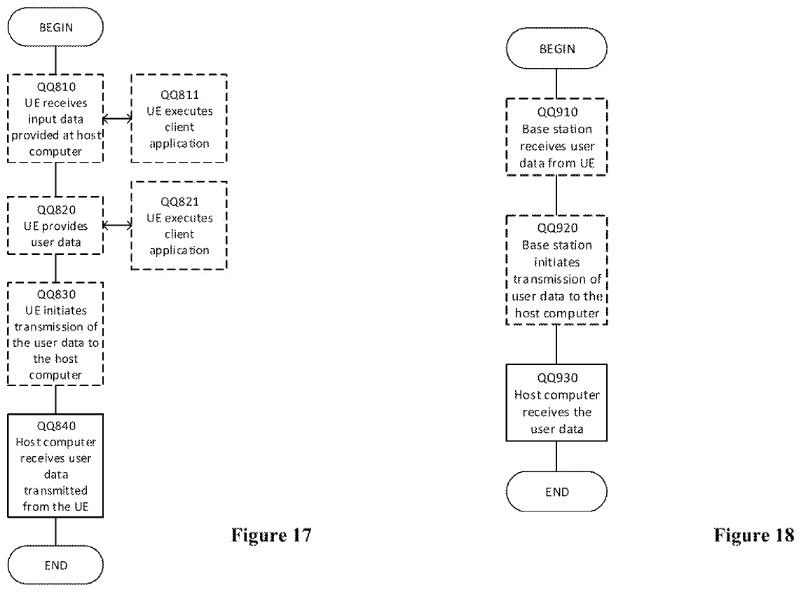

FIG. 15 is a flowchart illustrating a method implemented in a communication system, in accordance with one embodiment. The communication system includes a host computer, a base station and a UE which may be those described with reference to Figures QQ4 and QQ5. For simplicity of the present disclosure, only drawing references to FIG. 15 will be included in this section. In step QQ910 (which may be optional), in accordance with the teachings of the embodiments described throughout this disclosure, the base station receives user data from the UE. In step QQ920 (which may be optional), the base station initiates transmission of the received user data to the host computer. In step QQ930 (which may be optional), the host computer receives the user data carried in the transmission initiated by the base station.

FIG. 16 illustrates a schematic block diagram of a virtual apparatus 1600 in a wireless network (for example, the wireless network shown in FIG. 7). The apparatus 1600 may be implemented in a wireless device or network node (e.g., wireless device QQ110 or network node QQ160 shown in FIG. 7). Apparatus 1600 is operable to carry out the example method described with reference to FIG. 5 or 6 and possibly any other processes or methods disclosed herein. It is also to be understood that the method of FIG. 5 or 6 is not necessarily carried out solely by apparatus 1600. At least some operations of the method can be performed by one or more other entities.

Virtual Apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause any modules 1610 of apparatus 1600 to perform corresponding functions according one or more embodiments of the present disclosure.

As illustrated in FIG. 16, apparatus 1600 includes modules 1610 such as an obtaining module, a determining module, a selecting module and a transmitting module. The obtaining module is configured to perform at least step 510 of method 500 in FIG. 5 or step 610 of method 600 of FIG. 6. The determining is configured to perform at least step 520 of method 500 in FIG. 5 or step 620 of method 600 of FIG. 6. The selecting module is configured to perform at least step 530 of method 500 in FIG. 5 or step 630 of method 600 of FIG. 6. The transmitting module is configured to perform at least step 540 of method 500 in FIG. 5 or step 640 of method 600 of FIG. 6.

The above-described embodiments are intended to be examples only. Alterations, modifications and variations may be effected to the particular embodiments by those of skill in the art without departing from the scope of the description, which is defined solely by the appended claims.

1. A method performed by a wireless device for Licensed Assisted Access (LAA), the method comprising:
receiving a first and a second opportunities for performing a first uplink transmission within a period of time, the first opportunity being received earlier than the second opportunity within the period of time;
performing the first uplink transmission using the first opportunity; and
determining a treatment of the second opportunity based on the first opportunity.

2. The method of claim 1, wherein determining the treatment of the second opportunity comprises suppressing the second opportunity in response to determining that the uplink transmission using the first opportunity was successful.

3. The method of claim 1, wherein determining the treatment of the second opportunity comprises considering the second opportunity as invalid in response to determining that the uplink transmission using the first opportunity was successful.

4. The method of claim 1, wherein determining the treatment of the second opportunity comprises not acting upon the second opportunity in response to determining that the first uplink transmission using the first opportunity was successful.

5. (canceled)

6. (canceled)

7. (canceled)

8. (canceled)

9. The method of claim 2, wherein suppressing the second transmission opportunity is based on a capability of the wireless device.

10. The method of claim 9, wherein the capability of the wireless device depends on a priority of data to be transmitted.

11. (canceled)

12. (canceled)

13. (canceled)

14. (canceled)

15. (canceled)

16. A wireless device for Licensed Assisted Access (LAA), comprising:
a network interface; and
processing circuitry communicatively connected to the network interface and configured to:
receive a first and a second opportunities for performing a first uplink transmission within a period of time, the first opportunity being received earlier than the second opportunity within the period of time;
perform the first uplink transmission using the first opportunity; and
determine a treatment of the second opportunity based on the first opportunity.

17. The wireless device of claim 16, wherein the processing circuitry is configured to determine the treatment of the second opportunity by suppressing the second opportunity in response to determining that the uplink transmission using the first opportunity was successful.

18. The wireless device of claim 16, wherein the processing circuitry is configured to determine the treatment of the second opportunity by considering the second opportunity as invalid in response to determining that the uplink transmission using the first opportunity was successful.

19. The wireless device of claim 16, wherein the processing circuitry is configured to determine the treatment of the second opportunity by not acting upon the second opportunity in response to determining that the first uplink transmission using the first opportunity was successful.

20. The wireless device of claim 16, wherein the first transmission opportunity is one of a scheduled grant from a network node for the uplink transmission and an autonomous uplink access.

21. The wireless device of claim 16, wherein the second transmission opportunity is one of an autonomous uplink access and a scheduled grant from a network node for the uplink transmission.

22. (canceled)

23. (canceled)

24. The wireless device of claim 17, wherein the processing circuitry is configured to suppress the second transmission opportunity based on a capability of the wireless device.

25. The wireless device of claim 24, wherein the capability of the wireless device depends on a priority of data to be transmitted.

26. The wireless device of claim 17, wherein the processing circuitry is configured to suppress the second transmission opportunity based on an indication received from a network node.

27. The wireless device of claim 26, wherein the indication is received in a Radio Resource Control (RRC) signaling.

28. The wireless device of claim 17, wherein the processing circuitry is configured to suppress the second transmission opportunity based on the second transmission opportunity being a grant for a new transmission.

29. The wireless device of claim 16, wherein the processing circuitry is configured to determine the treatment of the second opportunity by performing a second uplink transmission using the second transmission opportunity in response to determining that the first uplink transmission using the first opportunity is successful, wherein the first uplink transmission is different from the second uplink transmission.

30. The wireless device of claim 16, wherein the processing circuitry is configured to determine the treatment of the second opportunity by performing the first uplink transmission using the second transmission opportunity in response to determining that the first uplink transmission using the first transmission opportunity has failed.

31. (canceled)

32. (canceled)

33. (canceled)

34. (canceled)

35. (canceled)

36. A network node for Licensed Assisted Access (LAA), comprising:
a network interface; and
processing circuitry communicatively connected to the network interface and configured to:
send a grant to a wireless device for indicating an uplink transmission opportunity during a period of time;
receive, during the period of time, an uplink transmission using resources not indicated by the sent grant;
in response to receiving the uplink transmission, send an indication to the wireless device to suppress the sent grant before the period of time expires.

37. (canceled)
